(19) United States
(12) Patent Application Publication
(10) Pub. No.: US 2021/0143629 A1
(43) Pub. Date: May 13, 2021

(54) PROTECTIVE DEVICE FOR PROTECTING AN ELECTRIC LOAD

(71) Applicant: Phoenix Contact GmbH & Co. KG, Blomberg (DE)

(72) Inventor: Elmar Schaper, Luegde (DE)

(21) Appl. No.: 16/623,664

(22) PCT Filed: Jul. 3, 2018
(86) PCT No.: PCT/EP2018/067887

§ 371 Date: Dec. 17, 2019

(30) Foreign Application Priority Data
Jul. 21, 2017 (DE) 10 2017 116 489.8

(51) Int. Cl. H02H 3/08; H02H 1/00

(52) U.S. Cl. CPC H02H 3/085; H02H 1/0007

(57) ABSTRACT

A protection device for protecting an electrical load, from a short-circuit current, comprising a line arrangement having a first electrical line and a second electrical line for supplying the electrical load with electrical energy, the first electrical line having a first line constriction having a reduced line cross-section and the second electrical line having a second line constriction having a reduced line cross-section, the first line constriction and the second line constriction being arranged adjacent to each other, and comprising at least one insulation layer which electrically insulates the first line constriction from the second constriction the at least one insulation layer being thermally destructible in dependence on temperature.

### CROSS-REFERENCES

The present application is a national stage entry of international application PCT/EP2018/067887, filed 3 Jul. 2018, entitled “PROTECTION DEVICE FOR PROTECTING AN ELECTRICAL LOAD”, and claims the benefit of German Patent Application No. 10 2017 116 489.8, filed 21 Jul. 2017, entitled “SCHUTZVORRICHTUNG ZUNI SCHUTZ EINES ELEKTRISCHEN VERBRAUCHERS”. Each of these applications is incorporated by reference herein for all purposes.

### BACKGROUND

The present disclosure relates to a protective device for protecting an electric load, which is electrically connected downstream of the protective device, against a short-circuit current in a polyphase AC network.

In an electrical power grid protection against electrical short circuits may be required for safety reasons. This short-circuit protection can be realized with a current-limiting switching element, for example with a fuse and/or a circuit breaker. The current limiting switching element may be configured to prevent the electric current flow from the electrical power supply network to an electric load when a current limit value is exceeded.

The effective protective effect of the current limiting switching element is described by means of the forward current, which defines the maximum value of the electric current before being limited by the current limiting switching element, and/or by means of the tripping energy, which defines the amount of energy necessary for triggering the current limiting switching element. The protective effect can be implemented differently based on connection values of the electrical energy supply network and/or an impedance that is effective in the event of an electrical short circuit.

Known protective devices have the disadvantage that when the current limit value of an electric current which only flows for a short time is exceeded, for example, a starting current of an electric motor triggers the protective device, wherein a disconnection of the power supply would not have been necessary. Furthermore, known protective devices may have a latency period between the exceeding of the current limit and the elimination of the electrical current flow to the electric load, during which latency the electrical current may continue to increase and may be outside a maximum current allowable for the electric load.

### SUMMARY

It is the object of the present disclosure to provide a more efficient protective device for preventing a flow of short-circuit current to an electric load.

This object is solved by the features of the independent claims. Advantageous examples are subject of the dependent claims, the description and the accompanying figures.

The present disclosure is based on the finding that the above object can be achieved by a protective device, which has at least two electrically insulated electrical leads, which supply electrical energy to the electric load, wherein between the electrical leads upon reaching a current limit in one of electrical lines are electrically connected to prevent flow of the electric current with a current above the current limit to the electric load. In particular, after establishing the electrically conductive connection between the at least two electrical lines, an electric current flows between the electrical lines and in particular not to the electric load.

According to a first aspect, the disclosure relates to a protective device for protecting an electric load, which is, for example, electrically connected downstream of the protective device, before a short circuit current. The protective device comprises a line arrangement with a first electrical line and a second electrical line for supplying the electric load with electrical energy, wherein the first electrical line has a first line narrow section with a reduced line cross-section and the second electrical line has a second line narrow section with a reduced line cross-section, wherein the first line narrow section and the second line narrow section are arranged adjacent to each other. Furthermore, the protective device comprises at least one insulating layer, which electrically isolates the first line narrow section from the second line narrow section, wherein the at least one insulating layer is temperature-dependently thermally destructible. The first line narrow section and/or the second line narrow section are electrically heated by a current flow and the at least one insulating layer can be thermally activated to thermally destroy the at least one insulating layer upon reaching a predetermined current of the current flowing through the line arrangement and thereby conductively connecting the first electrical line with the second electrical line electrically.

It can be particularly advantageous to prevent the supply of the electric load with electrical energy, if an electric current flows with a current outside a tolerance range of the electric load. This can be in particular the case in the event of an electrical short circuit and/or ground fault. The protective device according to the present disclosure can provide by means of the electrical connection between the two electrical lines, a bypass connection for deriving the short-circuit current. The short-circuit current flows through the bypass connection and not to the electric load. One shutdown device electrically upstream of the protective device, which triggers in particular with a delay relative to the protective device according to the present disclosure, can absorb the short-circuit current and interrupt, for example, one of the electrical lines to prevent the flow of current to the electric load.

The electrical lines may have an ohmic resistance, so that an electrical power loss can occur, which is converted into heat and increases the temperature of the electrical lines. The temperature of the insulating layer can be increased by heat conduction from the electrical wires to the insulating layer. Since the power loss can be proportional to the current of the electrical current flowing through the electrical lines, advantageously the temperature of the electrical lines can be used as a measure of the current of the electrical current.

The line galleries may be subjected to a mechanical stress to each other, in particular a pressure and/or bending stress, so that after a thermal destruction of the insulating layer the line narrow sections can be brought into direct electrical contact in particular by at least partial relaxation of the mechanical stress. Furthermore, an electrical contact between the line narrow sections may be prepared by a sparkover, in particular in the form of an electric arc between the line narrow sections. This can be realized by a flow of the short-circuit current with a high current, for example, a current in the range of 500 A to 1500 A or in the range of 10 kA to 100 kA.

In one example, the at least one insulation layer is formed by a cover of the first electrical line and/or the second electrical line. As a result, the advantage is achieved that the insulating layer protects the at least one electrical line from contact and/or from electrical contact with another conductor. The insulation layer may further surround both electrical lines and/or further electrical lines and thereby electrically separating them from each other.

In one example, the at least one insulating layer melts and/or vaporizes upon reaching a predetermined temperature of the at least one insulating layer. Thereby, the advantage is achieved that with the melting temperature of the insulating layer, an electric power amount can be defined, which is transported by the electrical lines, in which the formation of an electrically conductive connection between the electrical lines is provided. The amount of electric power may be defined by a period of time and the current of the electric current flowing through the electric lines.

The evaporation and/or melting of the insulation layer may be a non-reversible process, so that between the line narrow sections after melting and/or evaporation of the insulation layer, the insulation layer is no longer present. An electrically conductive connection between the line narrow sections can be realized by a direct contact of the line narrow sections or by a flashover, respectively electric arc between the line narrow sections.

In one example, by means of a selectable characteristic, in particular a thickness, the at least one insulation layer is predetermined to have a time interval after which the at least one insulation layer is electrically conductive and/or destroyed when the predetermined temperature is reached by the first line narrow section and/or the second line narrow section. The predetermined temperature may be, for example, 260° C. or above, wherein at temperatures below, for example, 155° C., the insulation layer realizes the electrical isolation of line narrow sections unchanged. This temperature behavior can be realized for example with an insulating layer comprising an insulating varnish and/or a plastic, in particular a polyurethane.

Due to the temperature-dependent destruction of the insulation layer, respectively, producing a conductive connection between the first line narrow section and the second line narrow section, after a conductive connection between the electrical lines is established the time interval over the cross section of the line narrow sections and/or the thickness of the insulating layer can be adjusted. The larger the cross-sectional area of the line narrow sections, the smaller the electrical resistance can be and the smaller the electrical power loss that is converted into heat during flowing though the line narrow sections. With a smaller amount of heat, the temperature of the insulating layer may be lower. As a result, the maximum possible current of an electrical current flowing through the electrical lines can be advantageously set via the cross-sectional area of the line narrow section, in which case the insulating layer is destroyed.

Furthermore, the thickness of the insulating layer can be used to set the time required to destroy the insulating layer. This achieves the advantage that, with a thickness of the insulating layer, a latency time between the flow of an electric current through the electrical lines with a predetermined current and the thermal destruction of the insulating layer can be adjusted.

In one example, the first line narrow section and the second line narrow section are immovable to inhibit repulsion of the first line narrow section and the second line narrow section from each other. Thereby, the advantage is achieved that the line narrow sections have a fixed distance from each other, so that, for example, a sparkover between the line narrow sections can be realized at a predetermined current and/or voltage of a current flowing through the line narrow sections. The current flow through the line narrow sections may also cause a Lorentz force, which can cause a repulsion of the line narrow sections from each other. This rejection can be advantageously prevented by fixing the line narrow sections.

In one example, the protective device comprises a printed circuit board, wherein the first line narrow section and the second line narrow section are fixed on the circuit board. The circuit board may also be enclosed by the insulating layer, so that only at input terminals and/or output terminals of the two electrical lines in each case an electrical connection with a supply line of a power supply line or an electric load can be realized. The circuit board can be electrically insulated by means of the insulating layer and/or protected from contact.

In one example, the at least one insulation layer is formed non-destructively when the electrical turn-on and/or rated current flows through the first electrical line and/or the second electrical line within a predetermined time interval, wherein the current of the electrical turn-on and/or rated current a multiple, in particular five times or ten times the current of a current permanently flowing through the first electrical line and/or the second electrical line. As a result, the advantage is achieved that the protective device maintains the power supply to the electric load during the flow of a temporary turn-on and/or rated current. In particular, the energy supply is not interrupted prematurely.

For example, an electric current flowing continuously through the protective device to the electric load can have a current in the range from 1 A to 100 A, in particular 6.5 A, wherein the current of the rated electrical current being ten times the current of the permanently flowing electrical current, in particular 65 A. The switch-on current flows during a time interval of 0.1 s to 10 s, in particular 2 s, during which time interval the insulation layer cannot be thermally destroyed. In particular, the rated current can flow at different, time-spaced time points, without the insulation layer being thermally destroyed.

In one example, the at least one insulation layer is formed by an insulating varnish on and/or a casing around the first line narrow section and/or the second line narrow section. As a result, the advantage is achieved that, for example, electrical lines already provided with an insulation layer can be used to produce the line narrow sections. In particular, winding wires, which are coated with an insulating varnish and/or a plastic can be used, which have a predetermined temperature and/or dielectric strength. The insulating varnish may for example be a copper varnish, which is applied to a wire. The plastic may in particular be a multi-stage polyurethane.

The cover can be adapted to at least partially enclose the line narrow sections and/or the electrical lines. In particular, isolation can be achieved by enclosing electrical insulation of the electrical lines and in particular of the line narrow sections by means of the insulating layer.

In one example, the line arrangement comprises a third electrical line, which is adapted to supply the electric load with electrical energy, and has a third line narrow section, which is disposed adjacent to the first line narrow section and/or the second line narrow section. Thereby, the advantage is achieved that the protective device is used for multi-phase AC grids, in particular three-phase networks, which have three different supply lines for supplying the electric load with electrical energy. The supply lines can be acted upon by an electric current, wherein each supply line may have a phase deviating from the other lines.

In one example, the first line narrow section, the second line narrow section, and the third line narrow section are disposed adjacent to one another. Thereby, the advantage is achieved that with the flow of a short-circuit current in one of the line narrow sections an electrical connection between all line narrow sections can be made. The insulation layer between the line narrow sections can be destroyed by the flow of the short-circuit current, so that the first, second and third line narrow sections can be electrically connected to each other.

In one example, the at least one insulation layer is arranged between the first line narrow section, the second line narrow section and the third line narrow section, wherein the at least one insulation layer is adapted to electrically isolate the line narrow sections from the further line narrow sections. Thereby, the advantage is achieved that the third electrical line with the third line narrow section can be electrically isolated from the first electrical line and the second electrical line. The insulating layer, which is connected in particular to the first, second and third line narrow section, can be adapted to realize an electrical connection between all line narrow sections when a short-circuit current flows in one of the line narrow sections. The insulation layer may be formed by separate adjacent line insulations and/or by a continuous medium in which the line narrow sections are embedded.

The adjacent line insulations may be in mechanical, in particular also in heat-conducting contact with each other, so that thermal loading in a region of the line insulation by means of heat conduction over the line insulations can also be realized by applying thermal heat to the remaining line insulations. Likewise, a locally limited thermal loading of the insulating layer by means of heat conduction in the insulating layer can realize a thermal loading of the entire insulating layer or at least further partial regions of the insulating layer. The thermal loading of the insulating layer can be realized in particular by a heat transfer from the line narrow sections to the insulating layer.

In one example, the first line narrow section and the second line narrow section are arranged in a first contact region adjacent to each other, in particular crossed. In particular, the first contact region may represent a spatially predetermined region for the thermal destruction of the insulating layer, at which an electrical connection with the respective remaining line narrow section can be realized. In particular, the insulation layer in the first contact region may have a thickness and/or temperature stability that deviates with respect to the further regions of the insulation layer, so that thermal destruction of the insulation layer can be realized only in the first contact region, and the other regions of the insulation layer independent of the electrical contact of the line narrow section maintain an electrically insulating function in the other areas of the insulation layer.

In one example, the third line narrow section is arranged in a second contact region adjacent to the first line narrow section and/or the second line narrow section and electrically insulated from the first line narrow section and/or the second line narrow section by the at least one insulation layer in the second contact region, wherein the first contact region and the second contact region are spaced apart from each other. Thereby, the advantage is achieved that an electrically conductive connection is made in the flow of a short-circuit current only between two line narrow sections, over which the short-circuit current can flow. The energy transport to the electric load can be obtained via the electrical line with the respectively remaining, electrically isolated line narrow section. By heat conduction, an electrical connection can be additionally realized in other contact areas. In particular, the electrical connection can be realized in the further contact areas after a time delay.

In one example, the third line narrow section is disposed in a third contact region adjacent to the first line narrow section and/or the second line narrow section and is electrically insulated by means of the at least one insulating layer in the third contact region of the first line narrow section and/or the second line narrow section, wherein the second contact region and the third contact area are spaced from each other. As a result, the advantage is achieved that a separate contact region is provided for each combination of at least two line narrow sections of the total of three line narrow sections, in which the electrical connection between the at least two line narrow sections can be realized. With the thermal destruction of the insulating layer at one of the line narrow sections, electrically conductive connections to the respective other line narrow sections can be realized in each case in two contact points. By way of example, the flow of a short-circuit current in the first line narrow section can realize an electrical connection between the first line narrow section and the second line narrow section in the first contact point.

In addition, a further electrical connection, which in particular is spaced apart from the existing electrical connection between the first line narrow section and the second line narrow section, can be realized between the first line narrow section and the third line narrow section in the second contact point.

In one example, the first line narrow section and/or the second line narrow section are thermally conductive in order to realize, when the predetermined temperature at the first contact region is exceeded, exceeding the predetermined temperature at the second contact region and/or at the third contact region. As a result, the advantage is achieved that a chain reaction realizes further electrical connections between the line narrow sections. As a result of the thermal conductivity of the insulating layer, the insulating layer can likewise be thermally stressed in further regions, which are arranged at a distance from the region of the insulating layer which is primarily exposed to thermal stress, wherein the insulating layer can likewise evaporate and/or melt in the further regions of the insulating layer in order to generate an electrically conductive connection between the respective line narrow sections.

In one example, the at least one insulation layer can be produced by encapsulation of the first line narrow section and/or the second line narrow section. As a result, the advantage of a particularly efficient production of the insulating layer is achieved. In particular, an individual thickness of the insulating layer can be realized by the encapsulation. The thickness of the insulating layer may also be thicker or thinner depending on the position of the line narrow sections and/or may include areas of the electrical lines in addition to the line narrow sections. The electrical lines may be at least partially enclosed by the insulating layer.

In one example, the line arrangement for each electrical line in each case comprises an input terminal and an output terminal. As a result, the advantage is achieved that the respective electrical lines can be subjected to different electrical potentials and/or different electrical currents. The different electrical currents may in particular have different phases.

The input terminals can realize a separable electrical connection between a supply line of a power supply line and the protective device. In one example, the input terminals form contact points for a non-detachable, in particular soldered, welded or pressed connection between the feed line and the protective device.

The output terminals can realize a separable electrical connection between the protective device and the electric load. In one example, the output terminals form contact points for a non-detachable, in particular soldered, welded or pressed connection between the protective device and the electric load.

According to a second aspect, the disclosure relates to a protection system for protecting an electric load from a short-circuit current. The protection system comprises a protective device according to the first aspect, which is connected upstream of the electric load, wherein the line arrangement for the first electrical line and the second electrical line each having an input terminal and an output terminal. Furthermore, the protection system comprises a power supply line for supplying the electric load with electrical energy, which comprises at least two electrical lines for transporting electrical energy to the electric load, wherein the electrical lines are each electrically connectable to one of the input terminals of the line arrangement, and a shutdown device, which is connected upstream of the protective device and is adapted to interrupt the electrical connection between the power supply line and the protective device in the presence of an electrical connection between the first electrical line and the second electrical line, in order to prevent the transport of electrical energy to the protective device when the electric current flows through the protective device, wherein the electric load is connectable to the output terminals of the protective device.

After an electrically conductive connection between the first line narrow section and the second line narrow section is made, a short-circuit current with a current that is outside a tolerance range of the protective device can flow through the line narrow sections, whereby by the ohmic resistance of the line narrow section a power loss, in particular in the form of heat is generated in the protective device. With the shutdown device, the flow of the short-circuit current can be prevented.

The shutdown device can prevent the flow of current in particular after a predetermined time interval after the insulation layer has been thermally destroyed. The insulation layer may be thermally destroyed, for example, in a time interval of 0.1 ms to 5 ms after the start of the flow of the short-circuit current and establish an electrical connection between the line narrow sections. The shutdown device can realize, for example, after a time interval of 5 ms to 15 ms after the start of the flow of the short-circuit current, a separation of the electrical connection between the power supply line and the protective device. The current of the short-circuit current can in particular increase continuously during the aforementioned time intervals, so that the current of the electric current flowing through the protective device can be greater, in particular greater by a factor of 2, 6 or 10, than an initial current at which an electrical connection between the line narrow sections is made and which is flowed to the electric load.

### BRIEF DESCRIPTION OF THE DRAWINGS

Further examples will be explained with reference to the accompanying figures. They show:

FIG. 1 shows a protective device according to an example;

FIG. 2 shows a protection system according to an example; and

FIG. 3 shows a protective device according to one example.

### DETAILED DESCRIPTION

FIG. 1 shows a schematic representation of the protective device 100 for protecting an electric load, which is connected downstream of the protective device 100. The protective device 100 comprises a line arrangement 101 with a first electrical line 103 and a second electrical line 105 for supplying the electric load with electrical energy. The first electrical line 103 has a first line narrow section 107 with a reduced line cross-section, and the second electrical line 105 has a second line narrow section 109 with a reduced line cross-section. The first line narrow section 107 and the second line narrow section 109 are disposed adjacent to each other. Furthermore, the protective device 100 comprises at least one insulation layer 111, which electrically isolates the first line narrow section 107 from the second line narrow section 109, wherein the at least one insulation layer 111 is thermally destructible depending on temperature. The first line narrow section 107 and/or the second line narrow section 109 are electrically heated by a current flow and the at least one insulating layer 111 is thermally acted upon to thermally destroy the at least one insulating layer 111 upon reaching a predetermined current of the current through the line assembly 101 and thereby the first electrical line 103 to be electrically connected to the second electrical line 105.

The at least one insulation layer 111 is formed by a cover of the first electrical line and the second electrical line 105. The at least one insulation layer 111 is further adapted to be non-destructive in respect to a flow of an electrical turn-on and/or rated current through the first electrical line 103 and/or the second electrical line 105 in a predetermined time interval. The current of the electrical turn-on and/or rated current is a multiple, in particular a fivefold or tenfold, of the current of an electric current flowing permanently through the first electrical line 103 and/or the second electrical line 105.

The first line narrow section 107 and the second line narrow section 109 are immovably adapted to prevent repulsion of the first line narrow section 107 and the second line narrow section 109 from each other. The line arrangement 101 further comprises a third electrical line 113 which is adapted to supply the electric load with electrical energy and has a third line narrow section 115, which is arranged adjacent to the first line narrow section 107 and/or the second line narrow section 109.

The at least one insulation layer 111 is arranged between the first line narrow section 107, the second line narrow section 109 and the third line narrow section 115, wherein the at least one insulation layer 111 is formed to electrically isolate the line narrow sections 107, 109, 115 from the further line narrow sections. Thus, the first line narrow section 107 is electrically insulated from the second line narrow section 109 and the third line narrow section 115 by means of the at least one insulation layer 111 and the second line narrow section 109 is electrically insulated from the third line narrow section 115.

The first line narrow section 107 and the second line narrow section 109 are arranged in a first contact region 117 adjacent to each other, in particular crossed. The third line narrow section 115 is arranged in a second contact region 119 adjacent to the first line narrow section 107 and is electrically insulated from the first line narrow section 107 by means of the at least one insulation layer 111 in the second contact region 119. The first contact region 117 and the second contact region 119 are arranged at a distance from one another. The third line narrow section 115 is disposed in a third contact region 121 adjacent to the second line narrow section 109 and is electrically insulated by the at least one insulating layer 111 in the third contact region 121 of the second line narrow section 109, wherein the second contact region 119 and the third contact region 121 are spaced from each other. Furthermore, the third contact region 121 is arranged at a distance from the first contact region 117.

The first line narrow section 107, the second p line narrow section inch 109 and/or the third line narrow section 115 are thermally conductive to realize when exceeding the predetermined temperature at the first contact region 117 an exceeding the predetermined temperature at the second contact region 119 and/or the third contact region 121.

The line arrangement 101 has, for each electrical line 103, 105, 113, an input terminals 123, 125, 127 and an output terminals 129, 131, 133, respectively. To the input terminals 123, 125, 127, in each case an electrical access line of a power supply line can be connected, and to the output terminals 129, 131, 133 each have an electric load, or a terminal of an electric load can be connected.

FIG. 2 shows a schematic representation of a protection system 200 for protecting an electric load 203 from a short-circuit current. The protection system 200 includes a protective device 100, which is connected upstream of the electric load 203. The protective device 100 comprises a line arrangement 101 having a first electrical line 103 and a second electrical line 105 for supplying the electric load 203 with electrical energy. The first electrical line 103 has a first line narrow section 107 with a reduced line cross-section, and the second electrical line 105 has a second line narrow section 109 with a reduced line cross-section. The first line narrow section 107 and the second line narrow section 109 are arranged adjacent to one another, wherein the line arrangement 101 for the first electrical line 103 and the second electrical line 105 each have an input terminal 123, 125, 127 and an output terminal 129, 131, 133.

Furthermore, the protective device 100 comprises at least one insulation layer 111, which electrically isolates the first line narrow section 107 from the second line narrow section 109, the at least one insulation layer 111 being temperature-dependently thermally destructible. The first line narrow section 107 and/or the second line narrow section 109 are electrically heated by a current flow and the at least one insulating layer 111 is thermally acted upon to thermally destroy the at least one insulating layer 111 upon reaching a predetermined current of the current flowing through the line assembly 101 and thereby the first electrical line 103 to be electrically connected to the second electrical line 105.

Furthermore, the protection system 200 includes a power supply line 205 for supplying the electric load 203 with electrical energy, which comprises at least three electrical leads 207, 209, 213 for transporting electrical energy to the electric load 203, wherein the electrical leads 207, 209, 213 are electrically connected with one of the input terminals 123, 125, 127 of the line assembly 101, respectively.

The protection system 200 further comprises a shutdown device 211, which is connected upstream of the protective device 100 and is adapted to interrupt the electrical connection between the power supply line 205 and the protective device 100 in the presence of an electrical connection between the first electrical line 103 and the second electrical line 105, in order when an electrical short-circuit current flows through the protective device 100 to prevent the transport of electrical energy to the protective device 100. The electric load 203 can be connected to the output terminals 129, 131, 133 of the protective device 100.

The protective device 100 further comprises a printed circuit board 201, wherein the first line narrow section 107, the second line narrow section 109 and/or the third line narrow section 115 are fixed on the circuit board 201.

The first line narrow section 107, the second line narrow section 109 and the third line narrow section 115 are disposed adjacent to each other. In particular, the line narrow sections 107, 109, 115 intersect in the first contact region 117, the line narrow section in the first contact region 117 being electrically insulated from each other by means of the at least one insulation layer 111.

FIG. 3 shows a schematic representation of the protective device 100 for protecting an electric load, which is electrically connected downstream of the protective device 100, before a short-circuit current. The protective device 100 comprises a line arrangement 101 with a first electrical line 103 and a second electrical line 105 for supplying the electric load with electrical energy. The first electrical line 103 has a first line narrow section 107 with a reduced line cross-section, and the second electrical line 105 has a second line narrow section 109 with a reduced line cross-section. The first line narrow section 107 and the second line narrow section 109 are disposed adjacent to each other. Furthermore, the protective device 100 comprises at least one insulation layer 111, which electrically isolates the first line narrow section 107 from the second line narrow section 109, wherein the at least one insulation layer 111 is thermally destructible depending on temperature. The first line narrow section 107 and/or the second line narrow section 109 are electrically heated by a current flow and the at least one insulating layer 111 is thermally acted upon to thermally destroy the at least one insulating layer 111 upon reaching a predetermined current of the current through the line assembly 101 and thereby the first electrical line 103 to be electrically connected to the second electrical line 105.

The at least one insulation layer 111 is formed by a cover around the first line narrow section 107, the second line narrow section 109 and/or the third line narrow section 115. In particular, the at least one insulation layer 111 encloses the printed circuit board 201.

The line arrangement 101 comprises a third electrical line 113, wherein the electrical lines 103, 105, 113 at a first end of the electrical lines 103, 105, 113 each have an input terminal 123, 125, 127 and at a second end of the electrical lines 103, 105, 113 each have an output terminal 129, 131, 133. The line arrangement 101 is adapted to transport electrical energy in the form of an alternating electrical current with an electrical voltage by means of the electrical lines 103, 105, 113 from a supply line connection to an electric load. In particular, an alternating current is transmitted via the electrical lines 103, 105, 113, which has a different phase with respect to the respective other electrical lines. In particular, the phase may be shifted by 30° between the first electrical line 107 and the second electrical line 109 and may be shifted between the second electrical line 109 and the third electrical line 113 by a further 30°, so that a phase difference of 60° between the first electrical line 107 and the third electrical line 113 is realized.

### LIST OF REFERENCE NUMBERS

100 protective device
101 line arrangement
103 first electric line
105 second electrical line
107 first line narrow section
109 second line narrow section
111 insulation layer
113 third electrical line
115 third line narrow section
117 first contact area
119 second contact area
121 third contact area
123 input terminal
125 input terminal
127 input terminal
129 output terminal
131 output terminal
133 output terminal
200 protection system
201 PCB
203 electric load
205 supply main line
207 electrical supply line
209 electrical supply line
211 shut-off device
213 electrical supply line

What is claimed is:

1. A protective device for protecting an electric load, which is electrically connected downstream of the protective device, before a short-circuit current, comprising:
a line arrangement having a first electrical line and a second electrical line configured to supply the electric load with electrical energy, wherein the first electrical line has a first line narrow section with a reduced line cross section and the second electrical line has a second line narrow section with a reduced line cross section, wherein the first line narrow section and the second line narrow section are arranged adjacent to each other; and
at least one insulation layer which electrically isolates the first line narrow section from the second line narrow section, wherein the at least one insulation layer is thermally destructible as a function of temperature;
wherein the first line narrow section and the second line narrow section are electrically heatable by a current flow and the at least one insulation layer is thermally loadable, such that the at least one insulation layer is thermally destroyed when reaching a threshold amount of the current through the line arrangement, causing the first electrical line to electrically conductively connect with the second electrical line.

2. The protective device according to claim 1, wherein the at least one insulation layer is formed by a cover of the first electrical line and/or the second electrical line.

3. The protective device according to claim 1, wherein the at least one insulating layer is configured to melts or evaporate upon reaching a threshold temperature of the at least one insulating layer.

4. The protective device according to claim 3, wherein a selectable characteristic of the at least one insulation layer defines a time interval, such that upon reaching or exceeding a threshold temperature for at least one time interval, the at least one insulation layer becomes electrically conductive or destroyed through one or both of the first line narrow section or the second line narrow section.

5. The protective device according to claim 1, wherein the first line narrow section and the second line narrow section are immovable with respect to each other to prevent repulsion of the first line narrow section and the second line narrow section from each other.

6. The protective device according to claim 5, further comprising a printed circuit board, wherein the first line narrow section and the second line narrow section are fixed on the printed circuit board.

7. The protective device according to claim 1, wherein at least one of the at least one insulation layer or the second electrical line is adapted to be non-destructive, wherein an electrical switch-on current or a rated current of the protective device is a multiple of a permanently flowing current through the first electrical line and/or the second electrical line.

8. The protective device according to claim 1, wherein the at least one insulating layer is formed by one or more of: an insulating varnish on the first line narrow section or the second line narrow section or a cover around the first line narrow section or the second line narrow section.

9. The protective device according to claim 1, wherein the line arrangement comprises a third electrical line adapted to supply the electric load with electrical energy, and a third line narrow section arranged adjacent to the first line narrow section or the second line narrow section.

10. The protective device of claim 9, wherein the first line narrow section, the second line narrow section, and the third line narrow section are disposed adjacent one another.

11. The protective device according to claim 9, wherein the at least one insulation layer is arranged between the first line narrow section, the second line narrow section, and the third line narrow section, wherein the at least one insulation layer is adapted to electrically isolate each of the line narrow sections from the other of the line narrow sections.

12. The protective device according to claim 1, wherein the first line narrow section and the second line narrow section are arranged adjacent to and crossing each other in a first contact region.

13. The protective device according to claim 12, wherein the third line narrow section is arranged adjacent to the first line narrow section or the second line narrow section in a second contact region, and wherein the third line narrow section is electrically isolated from the first line narrow section or the second line narrow section by at least one insulating layer in the second contact region, and wherein the first contact region and the second contact region are spaced from each other.

14. The protective device according to claim 13, wherein the third line narrow section is arranged adjacent to the first line narrow section or the second line narrow section in a third contact region, and wherein the third line narrow section is electrically insulated from the first line narrow section or the second line narrow section by at least one insulating layer in the third contact region, and wherein the second contact region and the third contact region are arranged at a distance from each other.

15. The protective device according to claim 14, wherein the first line narrow section and/or the second line narrow section are thermally conductive such that when a threshold to temperature is exceeded at the first contact region, the threshold temperature is also exceeded at the second contact region or the third contact region.

16. The protective device according to claim 1, wherein the at least one insulation layer is formed from an encapsulation of the first line narrow section or the second line narrow section.

17. The protective device according to claim 1, wherein the line arrangement for each electrical line has an input terminal and an output terminal respectively.

18. A protection system for protecting an electric load from a short circuit current, comprising:
a protective device, comprising:
a line arrangement having a first electrical line and a second electrical line configured to supply the electric load with electrical energy, wherein the first electrical line has a first line narrow section with a reduced line cross section and the second electrical line has a second line narrow section with a reduced line cross section, wherein the first line narrow section and the second line narrow section are arranged adjacent to each other; and
at least one insulation layer which electrically isolates the first line narrow section from the second line narrow section, wherein the at least one insulation layer is thermally destructible as at function of temperature;
wherein the first line narrow section and the second line narrow section are electrically heatable by a current flow and the at least one insulation layer is thermally loadable, such that the at least one insulation layer is thermally destroyed when reaching a threshold amount of the current through the line arrangement, causing the first electrical line to electrically conductively connect with the second electrical line;
wherein the line arrangement has, for each of the first electrical line and the second electrical line, an input terminal and an output terminal;
a power supply line for supplying the electric load with electrical energy, comprising two electrical lines configured to transport electrical energy to the electric load, wherein the electrical lines are each electrically connectable with one of the input terminals of the line assembly; and
a shutdown device connected upstream of the protective device, wherein the shutdown device is adapted to prevent the transport of electrical energy to the protective device when an electric short-circuit current flows through the protective device by interrupting an electrical connection between the power supply line and the protective device in the presence of an electrical connection between the first electrical line and the second electrical line;
wherein the electric load is connectable to the output terminals of the protective device.

19. The protective device of claim 4, wherein the selectable characteristic of the at least one insulation layer is a thickness of the at least one insulation layer.

20. The protective device according to claim 7, wherein the multiple is one of: five times the permanently flowing current or ten times the permanently flowing current.
